(19) United States
(12) Patent Application Publication
(10) Pub. No.: US 2017/0024659 A1
(43) Pub. Date: Jan. 26, 2017

(54) METHOD FOR DATA SEARCHING BY LEARNING AND GENERALIZING RELATIONAL CONCEPTS FROM A FEW POSITIVE EXAMPLES

(71) Applicant: BAE SYSTEMS Information and Electronic Systems Integration Inc., Nashua, NH (US)

(72) Inventor: Sean B. STROMSTEN, Arlington, MA (US)

(21) Appl. No.: 14/669,574

(22) Filed: Mar. 26, 2015

Related U.S. Application Data
(60) Provisional application No. 61/970,497, filed on Mar. 26, 2014.

(51) Int. Cl. G06N 99/00; G06F 17/30

(52) U.S. Cl. CPC G06N 99/005; G06F 17/3053; G06F 17/30536; G06F 17/30554; G06F 17/30979

(57) ABSTRACT

A system and method for improved data searching by generalizing/learning relational concepts and reducing the number and complexity of examples required to perform an example or concept based search. The system and the method providing ways for a user to generate relevant search parameters or features, that is, examples or concepts, with a non-query language or, alternatively, without coding, and thus, without necessitating expert knowledge of coding language.

### CROSS REFERENCE TO RELATED APPLICATIONS

The present Application is related to and claims the benefit of U.S. Provisional Patent Application Ser. No. 61/970,497 filed 26 Mar. 2014 by Sean B. Stromsten for a METHOD FOR GENERALIZING RELATIONAL CONCEPTS FROM VERY FEW POSITIVE EXAMPLES.

### STATEMENT REGARDING FEDERALLY SPONSORED RESEARCH

This invention was made with United States Government support under Contract No. FA8650-10-C-7059 awarded by U.S. Department of the Air Force. The United States Government has certain rights in this invention.

### FIELD OF THE INVENTION

The present invention relates to methods for teaching a computer to recognize instances of a concept and, more specifically, to methods for improved data searching and discovery by a computer by use of example based data searching using relational concepts learned from a few positive data examples.

### BACKGROUND OF THE INVENTION

Large data and knowledge bases including propriety data, such as that gathered by intelligence agencies or social networking sites, and public stores such as Cyc, DBPedia and Yago, are in common use and provide immeasurably valuable access to large bodies of information that are essential to a wide range of users and enterprises. Large databases and knowledge bases are, however, famously easier to accumulate than to use. Communicating with and querying or searching such large data and knowledge bases to retrieve specific information stored therein is difficult and typically demands expert level knowledge not only of a query language such as SPARQL, but also of the specific vocabulary and formats used to encode information stored in particular data and knowledge bases.

In particular relevance to the present invention, and for many of the same reasons, there have been no truly efficient and effective methods for structured querying with incomplete, partial or ambiguous query information, such as search by example or search by “concept”. Teaching a computer to recognize instances of a concept or of a data instance corresponding to an example, and to thereby enable a user to readily and efficiently conduct concept or example based searches is commonly a tedious and labor-intensive process. Typically, hundreds or thousands of examples and non-examples of the concept must be collected and labeled, and each must be represented by some set of features judged by an expert to be potentially useful to distinguish members from non-members.

Such successes in data searching with incomplete, partial or ambiguous query information as have been achieved with the known methods of the prior art, such as by previously existing data classification and database query tools, have suffered from either low expressivity (very limited hypothesis spaces) or limited capabilities for searching with incomplete, partial or non-specific information.

Some methods, such as inductive logic programming, may overcome the hypothesis space limitation, but are burdensome to implement and use because they require many examples, including negative examples. Some ILP work on classification learning, such as (Natarajan et al., 2010), addressed the problem of learning from positive examples with ad hoc methods, by, for example, selecting random items as probable negative examples. The results, however, have been limited and unsatisfactory because ILP methods in general do not exploit the strong sampling assumption, and do not average hypotheses, both of which are necessary for example based searches based on a few, possibly incomplete, examples.

From the above discussions of the pertinent prior art it is therefore apparent that a need exists for a tool for learning a relational concept, without complete certainty but well enough to make meaningful generalizations, from a very few positive examples, allowing arbitrary prior knowledge, including that created by previous application of this tool. A need exists to provide a system and method that learns and generalizes concepts from examples and permits data searching using incomplete, partial or ambiguous examples. In a related problem, there also exists a need for a data and knowledge base querying method that does not require knowledge of a query language or database schema vocabulary.

### SUMMARY OF THE INVENTION

Wherefore, it is an object of the present invention to overcome the above mentioned shortcomings and drawbacks associated with the prior art.

The present invention which is hereafter referred to as “Discovery By Example” (and abbreviated as “DBE” herein) is directed to a method for learning and generalizing relations from only a few positive examples. The method includes the steps of: (a) applying a modified Bayesian scoring rule for example commonality hypotheses based on statistical and database completeness assumptions which focuses on the distinctive commonalities of examples; and (b) organizing, prioritizing and searching an large space of commonality hypotheses defined by an expressive hypothesis language.

Expressed in further detail, the present invention DBE is a system and method for example based searches of a large hypothesis space (h-space) in a data system wherein the method of the present invention includes (a) generating a lattice data structure of example-covering hypotheses including the steps of (a1) selecting hypotheses from the hypotheses data structure, (a2) adding each selected initial parent hypotheses to the hypotheses lattice, and (a3) generating and adding at least one child hypotheses to the lattice wherein each child hypotheses is generated from a parent hypotheses of the lattice by specialization operators.

The method of the present invention further includes the steps of: (b) upon receiving a query example to be searched, (b1) selecting at least one hypothesis candidate as representing a potential solution of the query by comparing the query example with the at least one hypotheses selected from the lattice, (b2) scoring at least one hypothesis selected from the lattice according to a criteria of relevance to the query example and generating a corresponding solution likelihood value representing a probability that the corresponding hypothesis is a valid solution to the query example, and (b3) selecting as at least one response to the query example at least one candidate hypothesis selected from the lattice having a comparison score greater than a predetermined lower limit.

According to the present invention, the selection of initial parent hypotheses is based upon a heuristic selection criteria including at least one of complexity, wherein complexity is determined by a number of variables in a definition of an initial hypothesis, and well-formedness, wherein well-formedness between the initial parent hypothesis under consideration and a second initial parent hypothesis of lesser complexity.

In exemplary embodiments of the present invention, the specialization operators generating child hypotheses include at least one of: the addition of a literal to a parent hypothesis; the narrowing of a literal relationship by replacing a predicate of a literal with an immediate sub-relation predicate; the collapse of a variable by replacing all instances of the variable with another variable; and the instantiating of a variable by replacing the variable with a constant.

Further in this regard, the step of adding each selected initial parent hypotheses to the hypotheses lattice comprises adding each initial parent hypothesis to a corresponding lattice arc of the lattice, and the step of adding least one child hypotheses to the lattice comprises adding the child hypothesis to a sub-lattice arc corresponding to the lattice arc corresponding to the parent hypothesis from which the child hypothesis was generated.

The step of adding at least one child hypothesis to the lattice further includes the step of adding at least one next generation child hypothesis to the lattice by selecting a child hypothesis to be a successor hypothesis to be operated upon by at least specialization operator, operating upon the successor hypothesis with at least one specialization operation to generate at least one next generation child hypothesis, and adding each next generation child hypothesis to the lattice arc of the successor hypothesis.

The step of selecting a child hypothesis to be a successor hypothesis includes (1) determining a promise value for a child hypothesis wherein a promise value is a function of at least one of an example coverage value representing a degree to which the child hypothesis matches the query example, a hypothesis relevance value representing a degree to which the child example relates to the query example, and a simplicity value representing the number of literals and variables defining the child hypothesis, and (2) selecting for use as successor hypotheses those child hypotheses having a promise value greater than a predetermined value.

According to further aspects of the present invention, the step of generating and adding at least one child hypotheses to the lattice further comprises the step of eliminating non-relevant hypotheses from the lattice.

In this aspect of the present invention, hypotheses are selected for elimination from the lattice according to a criteria including at least one of being overly inclusive, being overly exclusive, being redundant with regard to other hypotheses, membership of a class of hypothesis, complexity, well-formedness or relevance to potential query examples.

In yet another aspect of the present invention, the elimination of non-relevant hypotheses from the lattice is performed during at least one of the addition of hypotheses and child hypotheses to the lattice and after generation of the hypotheses space.

According to the present invention, and upon receiving a query example, candidate hypotheses potentially representing a solution to the query example are selected from the lattice for scoring by at least one of the selection of successive hypotheses from the lattice, the determination of relevance of a hypotheses to the query example, and the selection of candidate hypotheses by comparison between elements of the query example and elements of the hypotheses.

The candidate hypotheses are then scored by determining a degree of relevance of hypotheses elements of each candidate hypothesis that matches at least one hypotheses element of the query example and generating, for each candidate hypothesis, a solution likelihood value representing the probability that the candidate hypotheses is a valid solution to the query example.

At least one candidate hypothesis is selected as a potential solution to the query example, each of the candidate hypotheses having a solution likelihood value greater than a predetermined lower limit are compared and ranked, and the at least the candidate hypothesis, having the greatest solution likelihood value as a solution to the query example, is selected.

### BRIEF DESCRIPTION OF THE DRAWINGS

The accompanying drawings, which are incorporated in and constitute a part of the specification, illustrate an embodiment of the invention and together with the general description of the invention given above and the detailed description of the drawings given below, serve to explain the principles of the invention. The invention will now be described, by way of example, with reference to the accompanying drawings in which:

FIG. 1 is a diagrammatic illustration of a general overview of a system for use with the present invention.

FIG. 2 is a diagrammatic illustration of an overview of processes and method steps for implementing an embodiment of the present invention.

FIG. 3 is another diagrammatic illustration of the processes and method steps for implementing the present invention.

FIG. 4 is a diagrammatic illustration of the interrelation of the lattice and lattice generation and winnowing processes and method steps of the present invention.

### DETAILED DESCRIPTION OF THE PREFERRED EMBODIMENTS

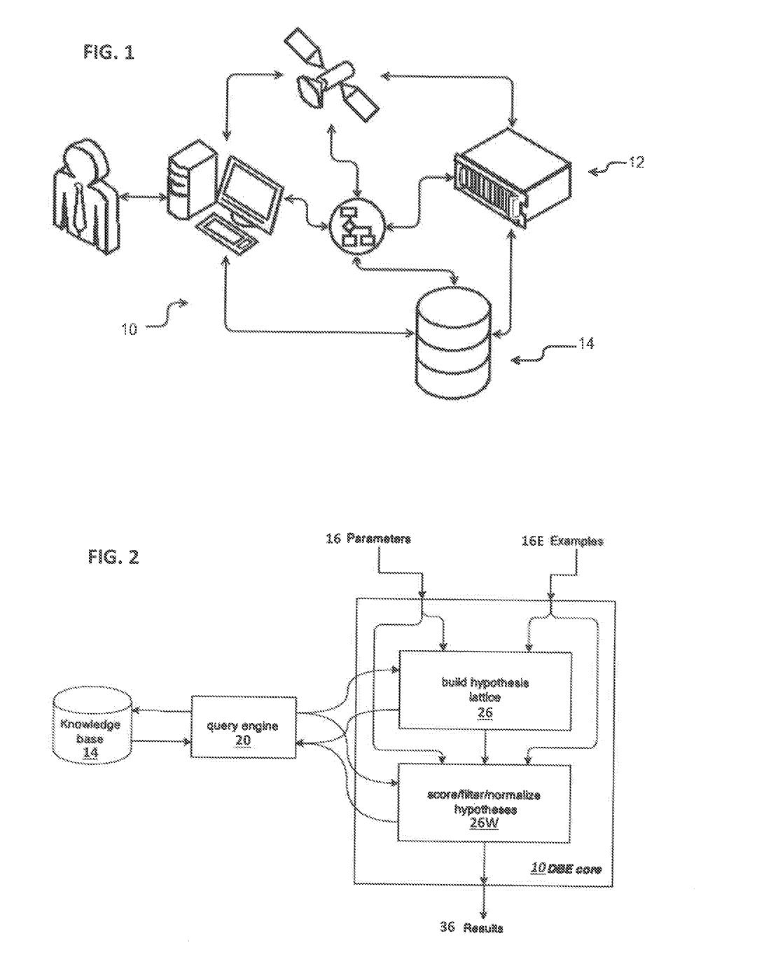

The following detailed description is provided with reference to FIGS. 1-4 illustrating embodiments of the present invention. The end product of the algorithm of the system is a set of scored, well-formed, example-covering hypotheses, which can be directly presented to the user for approval, and which can also be used to generalize (in a graded fashion) from the examples to other objects or tuples that match these hypotheses. Generalization is strongest to objects or tuples in the extensions of the highest-scoring hypotheses.

According to and for purposes of the present invention, a hypothesis is a logical definition, or predicate, in some formal language such prolog, SQL, or SPARQL, that picks out a subset of the objects (or tuples, in the case where the examples are tuples) in the database. The following rule (written with the convention that uppercase letters like X are variables, for which constants in the database may be substituted, when they satisfy the rule's constraints):
X is ac if and only if
   X has fur
   X lives With Y
   Y a human
      is satisfied by just that set of objects that (according to the database) both have fur and live with a human. This set of objects (or tuples) is herein called the “extension” of the hypothesis, and the number of objects or tuples in the extension is herein called the “extent” of the hypothesis. Members of this set are said to be covered by the hypothesis definition.

For purposes of the present invention, several properties of a hypothesis are defined. A hypothesis is “example covering” if it covers a sufficient number or a fraction of the given examples, where the number or the fraction of non-covered examples that can be tolerated is a parameter which is controlled by the user. In the simplest case, all examples must be covered. The “complexity” of a hypothesis is an increasing function of both a) the number of constraints in and b) the number of variables in the hypothesis's definition. The “simplicity” of a hypothesis is the inverse of its complexity. The “relevance” of a hypothesis is defined with reference to a predefined or user-provided list of relation and class relevance scores, where the high-scoring relations and classes are those of special interest to the user. The relevance scores of both relations and classes are “inherited upwards”—that is, if “friend of” is considered highly relevant, then the weaker, more inclusive relation, “knows”, is also considered highly relevant. A hypothesis's relevance increases with the average relevance of the relations and classes occurring in the definition. A hypothesis is “well formed” if it is not provably equivalent (with minimal effort) to a simpler hypothesis (a simple example of an ill-formed hypothesis is one that duplicates a constraint). The “score” of a hypothesis can be interpreted as a Bayesian posterior probability, but can be understood qualitatively as favoring (a) specificity—that is, small extent, (b) simplicity, (c) relevance, and (d) well-formedness. In some embodiments, the examples are assumed to have been drawn at random from the extension of some such predicate.

According to and for purposes of the present invention, a hypothesis space is a set of hypotheses defined by (1) one or more “root” (initial parent) hypotheses, such as the trivial hypotheses covering all objects (or tuples) in the database; (2) a set of specialization operators, which map any hypothesis h-herein designated the “parent” hypothesis—to a (potentially empty) set children hypotheses (h) of legal, example-covering hypotheses whose extensions are guaranteed to be subsets of the children hypotheses h; and (3) some complexity limits to guarantee that the search space is finite.

In this description of the current invention, a specialization operator maps a parent hypothesis to a child hypothesis by either adding a constraint to the definition of the parent hypothesis, narrowing a relation in the definition of the parent hypothesis, changing two distinct variables in the parent hypothesis to one variable, or replacing a variable in the parent hypothesis with a constant occurring in the database. A specialization child hypothesis is kept only if it is example covering. Because many of these specializations may be applicable, a parent hypothesis will, in general, have several children. Because different sequences of specializations can lead from an ancestor (initial parent, parent or root) hypothesis to a descendant (child) hypothesis, the specializations define a lattice.

According to the present invention, the lattice of example-covering hypotheses is generated by the following process:
1. Initialize a lattice to contain only a trivial hypothesis.
2. Initialize a list of hypotheses called “open” to contain only the trivial hypothesis.
3. Initialize a list called “closed”, which is initially an empty list.
4. Initialize a counter “iteration” to zero.
5. Repeat until “open” is empty, or until “iteration” exceeds some specified limit by:
   a. Removing the first element hypothesis from the “open” list and adding it to the “closed” list;
   b. Incrementing the “iteration” counter;
   c. Generating all the legal, example covering children of parent hypotheses, which set is herein designated children; and
   d. Inserting all members of children that are not already in “closed” list into “open” list, in descending order of promise, which is an increasing function of example coverage (only relevant when some non-covered examples are tolerated), simplicity, and relevance.

In the algorithm of the present invention, a set of scored, well-formed, example covering hypotheses is extracted from the lattice by the following process:
1. Initialize an “open” list to contain a leaf hypotheses of the lattice—that is, those hypotheses with no children. At least one of these hypotheses is guaranteed to have the least extent among all hypotheses in the lattice, herein called “min-extent”.
2. Initialize a “closed” list which is initially an empty list.
3. Repeat until the “open” list is empty by the following process:
   a. Remove the first element hypothesis of the “open” list and add it to the “closed” list;
   b. Score the moved hypothesis;
   c. Retrieve the set of parents of the moved hypothesis, herein called parent hypothesis set;
   d. Remove from the parent hypothesis set any hypothesis whose extent is too large, relative to “min-extent”, according to a specified ratio threshold;
   e. Add all members of the parent hypothesis set to the “open” list; and
   f. Add all well-formed members of parent hypothesis set to the “closed” list.

When this process terminates, the “closed” list will contain the desired list of scored, well-formed, example covering hypotheses. In the following, a detailed description of the present invention is provided.

### INTRODUCTION

Initially, the following description will first consider three general problems which are addressed by the present invention. Each of these apparently different problems have an essential similarity. This is followed by a description of the system and methods of the present invention which overcome these problems as well as the above mentioned shortcomings and drawbacks associated with the prior art.

The present invention contains a system that can learn relational concepts from a few positive examples (sometimes one example), which requires no negative examples. The system combines elements of inductive logic programming (an expressive and human-readable hypothesis language), easy incorporation of extensive background knowledge, organization of hypothesis search by the partial ordering provided by generalizes/specializes relations with a Bayesian based concept learning framework due to Tenenbaum (1999). In describing the present invention, a discussion is provided for showing how a number of apparently different tasks can be cast as relational concept learning. Next, a discussion regarding the rationale for and implementation of the system and demonstrate it on a wide range of problems in a toy world. Additional embodiments and alterations of the present invention are also discussed. Finally, a discussion is provided of an illustrated example of one embodiment of the present invention. Reference to the diagrammatic illustrations and detailed descriptions of this embodiment will be beneficial in understanding the general aspects and contexts of the present invention herein.

Problem 1: Learning Concepts from a Few Positive Examples

Suppose a set of examples, objects, or tuples 22 is drawn at random from a population of objects or tuples having “something” in common, but the DBE 10 does not yet know what that “something” is.

Given a first set of example objects 22: {e.g., Fido, Spot, Rover′}, DBE 10 would guess that all are instances of “dog names”. Of course, they are also all instances of “dog”, “animal” and “entity”, but they share these properties with many more objects than they do that of being dog names, so these answers are not as “good”, in some sense. A reasonable set of “more like these” will probably include dog names Snoopy and Max, might include cat Mittens, and probably won't include Mount Rushmore.

Given a second set of example objects 22: {e.g., (David Cameron, UK), (Angela Merkel, Germany)}, DBE 10 would give high weight to the distinctive relation that, in each pair, the first element bears the relation “is head of state of” to the second object. A second relation “lives in”, while also true of both pairs, is also true of millions of other pairs, so is not as good an answer. More pairs like these might include (Nicholas Sarkozy, France) and (Barack Obama, USA).

For each of these problems, DBE 10 needs to guess the commonality in order to (a) describe it and/or (b) find more objects or tuples like the examples 16E.

Problem 2: Solving Proportional Analogies

Another type of search problem commonly found, for example, in standardized tests is:
boat:water::airplane:?

A popular query answer 36 is “air”. Why is that a better answer than, say, “water”? After all, one might argue that the rule that relates these pairs is “some vehicle, then ‘water’”. Once again, the distinction between the “right” and “wrong” answers is specificity. While many pairs fit this “wrong” facetious definition, very few pairs fit the “right” definition (e.g., “vehicle type X that moves through fluid medium Y”). Roughly stated then, DBE 10 solves the analogy by learning a concept from one and a half examples 22, and then filling in the missing half.

Problem 3: Database Exploration

Large databases and knowledge bases are famously easier to accumulate than to use. Both special purpose data (e.g., proprietary data gathered by intelligence agencies or social networking sites) and general data (e.g., public domains, Cyc, DBPedia and Yago), offer the promise of going beyond information retrieval to a new level of query flexibility and precision (e.g., “fact retrieval”). However, communicating with these data stores is difficult, as doing so requires knowledge not only of a query language, such as SPARQL, but also of the specific vocabulary used to encode facts. For the purposes of the present invention, a query language is defined as a computer language used to make queries into databases and information systems. In contrast, a non-query language is defined as any spoken language (e.g., English, Spanish, French, German, Japanese, etc.).

Suppose a user want to know who directed “High Noon”. If the user knows SPARQL, and knows how dbpedia represents the relations “directed” and “has name”, then the user can issue this query:

```
        prefix dbpo: <http://dbpedia.org/ontology/>
        select distinct ?directorName
        where {
          ?film dbpo:director ?dir .
          ?film rdfs:label “High Noon”@en .
          ?dir rdfs:label ?directorName .
          filter(lang(?directorName) = “en”) .
        }
and get back the query result 36:
              “Fred Zinnemann”
```

However, even for a SPARQL expert, this is cumbersome, because it takes some time, even for an expert, to find out that the dbpedia notation for the “director” is http:/dbpedia.org/ontology/director.

In light of this, it will be apparent from the above examples of data and knowledge searching that, in contrast to the above discussed examples, it would be advantageous to be able to indicate which relation the user cares about by merely giving a few examples, such as:
North by Northwest, Alfred Hitchcock
The Sting, George Roy Hill
High Noon, ?x

This kind of example-based relation specification is an advantageous replacement or supplement for more complex SPARQL queries, such as the “High Noon” example above. For instance, the example from dbpedia above does not directly represent the desired relationship (e.g., “co-starred with”) at all, but rather extrapolates an answer only through a complicated implicit rule (e.g., “A co-starred with B if there is a movie M such that A acted in M and B acted in M”). DBE 10 utilizes merely a few examples in such a way that only a few examples suffice to find this rule and answer a question like “who co-starred with Betty Davis?”

DBE Solution: Brief Summary of Basic Concepts of the Present

In order to solve the three above noted problems as well as others, the present invention is directed to a method for “teaching” a computer to recognize instances of a concept or example. Moreover, DBE 10 is directed to methods executed on a computer or data system 12 for data search and discovery by a computer user 11, by use of example based data searching, using generalized/learned relational concepts generated from relatively few positive data examples 22.

As will become apparent from the following descriptions of the invention, the present invention drastically reduces the number and complexity of examples 22 required to perform an example or concept based search. DBE 10 also provides ways for the user to generate relevant search parameters or features, that is, examples or concepts, through a communication process 50 with the DBE 10 using a non-query language 52, or alternatively, without coding, and thus, without necessitating expert knowledge of the coding language. The present invention also relieves at least some of the tedium and arcana of querying large data accumulations, such as large data or knowledge bases, by allowing users to specify what kind of results 36 they are seeking by giving examples 22. According to the present invention, an initial query 22 containing only a small number of complete examples 22 and/or a partial example 22, when utilized with the hypothesis elements 20, can provide enough information to “fill in the missing pieces” of the initial query 22. Philosophically, DBE 10 does so much in the same manner as a human being solving an analogy puzzle.

As will be described in the following, DBE 10 is based upon a method or methods comprising (1) a Bayesian based scoring process 19 which comprises, for example, commonality hypotheses, which is based on statistical and database completeness assumptions and focuses in on distinctive commonalities among examples; and (2) a method of methods for organizing, prioritizing, and searching an expressive language of commonality hypotheses.

As will be described in detail in the following, the DBE Bayesian based scoring process 19 is new, unique, and unlike any other extant system, so direct comparison is impossible. Unlike most Bayesian modeling, and unlike the teachings of Tenenbaum (1999), the DBE Bayesian scoring rule formalization process 19 applies probabilistic reasoning to crisp, logical concepts.

Bayesian Based Probability Principles

Therefore, the following considers the Bayesian probability principles in further detail. Bayesian probability principles comprise an interpretation of the concept of probability and may be regarded as an extension of propositional logic that enables reasoning with hypotheses 16, that is, with propositions whose truth or falsity is uncertain. Bayesian probability principles are members of what may be referred to as evidential probabilities wherein the probability of a hypothesis 16 is based upon some known prior probability which is updated in the light of new, relevant data or evidence and wherein the Bayesian principles and methods provide a standard set of procedures and formula to perform this update calculation.

In contrast to interpreting probability as the “frequency” or “propensity” of some phenomenon, Bayesian probability is a quantity that is assigned for the purpose of representing a state of knowledge or state of belief. In the Bayesian view, a probability is assigned to a hypothesis 16 whereas under the frequentist or propensity methods a hypothesis is typically tested without being assigned a probability.

Under Bayesian principles, a probability may be interpreted in two ways. According to the objectivist interpretation, the rules of Bayesian statistics can be justified by requirements of rationality and consistently and interpreted as an extension of logic. However, according to the subjectivist interpretation, probability quantifies a “personal belief”.

Bayesian methods are characterized by certain concepts and procedures, such as:
(a) The use of random variables, or, more generally, unknown quantities, to model all sources of uncertainty in statistical models. This also includes uncertainty resulting from lack of information.
(b) The need to determine the prior probability distribution taking into account the available prior probability information.
(c) The use of Bayes' formula to calculate a new posterior distribution each time more data become available, whereby subsequently the previous posterior distribution becomes the next prior probability distribution.

In the frequentist interpretation of Bayesian probability, a hypothesis is a proposition which must be either true or false, so that the frequentist probability of a hypothesis is either one or zero, that is, true or not true. In Bayesian statistics, however, a probability can be assigned to a hypothesis 16 that can differ from 0 or 1 if the truth value is uncertain.

Binary classification using Bayesian probability, often called concept learning, is usually based on the assumption that examples are drawn at random from the general population of objects, and then tagged as positive (in the set defined by the concept) or negative (not in the set).

In developments of this methodology in the prior art, however, and because of the requirement for both positive and negative examples in prior art implementations of binary classification using Bayesian probability, it has again typically been necessary to employ a large number of examples and complex validity judgment criteria in order to order to perform searches using incomplete, partial or ambiguous search criteria.

The Bayesian Based Scoring Rule of the Present Invention

Binary classification, often called “concept learning”, as typically and commonly implemented in and for Bayesian modeling is usually based on the assumption that examples 22 are drawn at random from the general population of objects, and then tagged as positive (in the set defined by the concept) or negative (not in the set).

Unlike previous Bayesian modeling schemes, however, the DBE Bayesian scoring rule/process 19 of the present invention applies probabilistic reasoning to crisp, logical concepts. Wherein a “concept” is defined, for purposes of the present invention, as a set of items (or “tuples”), or some parameter, fact or data or information item that likewise defines such a set.

According to one embodiment of the invention, the elements of the DBE 10 Bayesian based scoring rule formalization process 19 comprise:
1. Initial Hypotheses Space Process 20: The construction and/or providing of a previously constructed hypothesis space 28, that is, a set of possible concept definitions, each of which defines a set of objects or tuples 18, referred to as the concept's “extension.” Typically, only concepts that define sets by logical conditions, rather than by enumeration of the extension, are considered.
2. Initial Prior Probability Distribution Process 42: The construction and/or providing of a previously constructed prior probability distribution over the concept hypotheses in the hypothesis space or “h-space” 28.
3. Initial Assumption Process 44: The construction and/or providing of one sampling assumption 46 (e.g., a previously constructed “strong sampling” assumption 46). In doing so, DBE 10 makes an assumption 46 that examples 22 are drawn uniformly at random from the members 18 of the exemplified concept (which is itself assumed to be drawn from the prior existing examples 18 above).
4. The execution of a Bayesian Hypothesis Averaging Process 48, that is, DBE 10 computes the probability that some probe item or tuple 18 is in the exemplified concept of the example 22 by combining predictions from all hypothesis 16 consistent with the data, rather than picking one “best” one. This is particularly important with few examples 22 and/or dense hypothesis spaces 28 (e.g., those with continuous parameters), in which case no single hypothesis 16 is likely to emerge as a clear result 36.

It is this strong sampling assumption 46 that embodies (and quantifies) the preference for specific hypotheses: one is more likely to draw item A from a bag containing A and just a few other items than from a bag containing A and many other items. It is assumed that examples are drawn with replacement from the entire group of examples, but the math is only slightly different if they are drawn without replacement. Mathematically, it makes little difference to the probabilities of each, unless the set of entire examples is countable and very small.

Several variations on this strong sampling assumption 46 are simple and useful. One assumption, the broad sampling assumption 46, is that, with some small probability, each example 22 is drawn, not from the target concept, but from some larger set, such as the set of all items or tuples. This prevents ignorance of some fact necessary to prove one example 22 from causing the outright rejection of an otherwise very good hypothesis 16.

Another assumption variation, the special sampling assumption 46, accords special treatment to literals connecting names with things, since it might plausibly be either the things or the names that are drawn at random. For instance, if DBE 10 draws people at random from the set of students at some American school, people named “Michael” will occur more often than those named “Johan” or “Isaac.” If DBE 10 chooses from among unique names at the school, however, those that occurred at all would be equally likely.

Considering the above method steps for creation of the DBE Bayesian Scoring Rule Formalization 19, the present invention DBE 10 Bayesian based process may be presented more formally if xₜ is defined as a new item (possibly a tuple), which may or may not be in the unknown concept C exemplified by the n examples x₁ to xₙ. Then, according to one embodiment of the present invention, the probability that xₜ is a member of concept C is mathematically obtained by summing over possible concept C, indexed by h (for “hypothesis”):

$$p ( {x}_{t} ∈ C \vert {x}_{1 \text{:} n} \sim C ) = {\sum }_{h} p ( C = h \vert {x}_{1 : n} C ) p ( {x}_{t} ∈ h )$$

Where for purposes of this invention, the ˜ symbol means “is drawn at random from.” The second term can be absorbed into the summation, and the first inverted by Bayes rule yielding:

$$p ( {x}_{t} ∈ C \vert {x}_{1 \text{:} n} \sim C ) \frac{{\sum }_{h ⊃ {x}_{t}} p ( {x}_{1 \text{:} n} \sim h ) p ( C - h )}{p ( {x}_{1 \text{:} n} \sim C )}$$

Where, for purposes of this invention, the ⊃ symbol means “containing”. Decomposing the denominator by the same summation over possible concepts, and noting that p(x˜h) is |h|⁻¹, (if xεh and zero otherwise), the user gets:

$$p ( {x}_{t} ∈ C \vert {x}_{1 \text{:} n} \sim C ) \frac{{\sum }_{h ⊃ {x}_{t} , {x}_{1 \text{:} n}} {\vert h \vert}^{- n} p ( C = h )}{{\sum }_{{h}^{′} ⊃ {x}_{1 \text{:} n}} {\vert {h}^{′} \vert}^{- n} p ( C = {h}^{′} )}$$

Focusing on the numerator (the denominator is constant in xₜ), it is noted that according to this embodiment of the present invention:
(1) the generalization probability for new item t is obtained by summing over hypotheses that include both xₜ and all the examples x_{1:n};
(2) the weight of hypothesis h's contribution to the sum is proportional to both its prior probability p(h) and its likelihood, |h|⁻ⁿ;
(3) the likelihood |h|⁻ⁿ of the hypothesis h is inversely proportional to the size of the hypothesis (the number or measure of possible x values that could have been drawn from it); and
(4) the likelihood |h|⁻ⁿ of the hypothesis h is exponential in the number of examples.

It is this exponential effect that makes it possible to learn from small numbers of examples. For this reason, a hypothesis h₁ (or hypothesis 16) made from the present invention that is even half the size of a competitor's hypothesis h₂, made using the prior art methods, has a thousand-fold advantage in likelihood over the competitor's hypothesis, given just 10 examples.

It should be noted with regard to the above discussions that, in practice, a likelihood model that generates non-members, with some small probability, improves robustness against gaps and errors in the knowledge base. Also, negative examples 22, if available, can be incorporated simply by setting to zero (false) the likelihood of any hypothesis 16 containing the value one (true).

### Incomplete Examples

Up to this point, the DBE 10 embodiments have considered only fully-known examples, for a given hypothesis h, each of whose likelihood is |h|⁻¹. However, other embodiments of the present invention consider incomplete examples. For the purposes of this invention, an incomplete example 22 is an event in which a complete example was drawn that matches the incomplete example. For example, (airplane,X), matches each of: (airplane,air), (airplane,water), and (airplane,molasses). Accordingly, then, in the above formalized method of DBE 10, a likelihood of the incomplete example is defined to be n*|h|⁻¹, where n is the number of elements in the extension of h matching the example. This definition generalizes the definition for complete examples, which are defined as each having at most one match.

Applying Bayesian Based Concept Learning Over Relational Concept Spaces

In one embodiment of the present invention, DBE 10 advantageously utilizes inductive logic programming (ILP). ILP is a sub-field of machine learning focused on highly-expressive concept languages, a typical example of which are predicates in the prolog programming language, and is useful as a tool and mechanism, as in the present invention, in defining and operating with complete and incomplete examples and concepts. For example, Prolog can represent relational concepts like “knows a member of” that essentially cannot be expressed in popular machine learning classifier mechanisms such as decision trees, logistic regression, neural networks, or support vector machines unless the kernel functions of the data system itself contains the expressiveness capabilities of Prolog.

Defining concepts or complete and incomplete examples as prolog predicates allows the present invention, DBE 10, to readily incorporate extensive background knowledge into the concepts and to produce definitions that are meaningful to humans. The form, vocabulary, and complexity of prolog predicates also provide a means for readily and effectively defining reasonable prior probability values.

Syntactically simple operators relate concepts to more-specific ones, and so provide a backbone for efficient navigation of the space. In one embodiment of the present invention, the DBE 10 adds extra specialization operators 32O which can take advantage of second-order (ontological) knowledge to better organize search; hypothesis averaging; and the “closed world” assumption, that is, the assumption that any propositions not derivable from the knowledge base are false. In particular, unless this assumption is relaxed as discussed further below, any item or tuple that cannot be proven to be a member of a concept hypothesis is not a member of that concept hypothesis.

Note that the focus of the discussion of the present invention DBE 10 is upon semantic web data, such as commonly found in the internet 56, represented as subject-predicate-object triples, so that the focus of the discussion of the present invention DBE 10 is primarily on the binary relations used therein. However, it is envisioned and apparent that this system, process, and method might be utilized to address other data sources and relations.

Structure and Operation of a DBE Method Implemented on a Data System

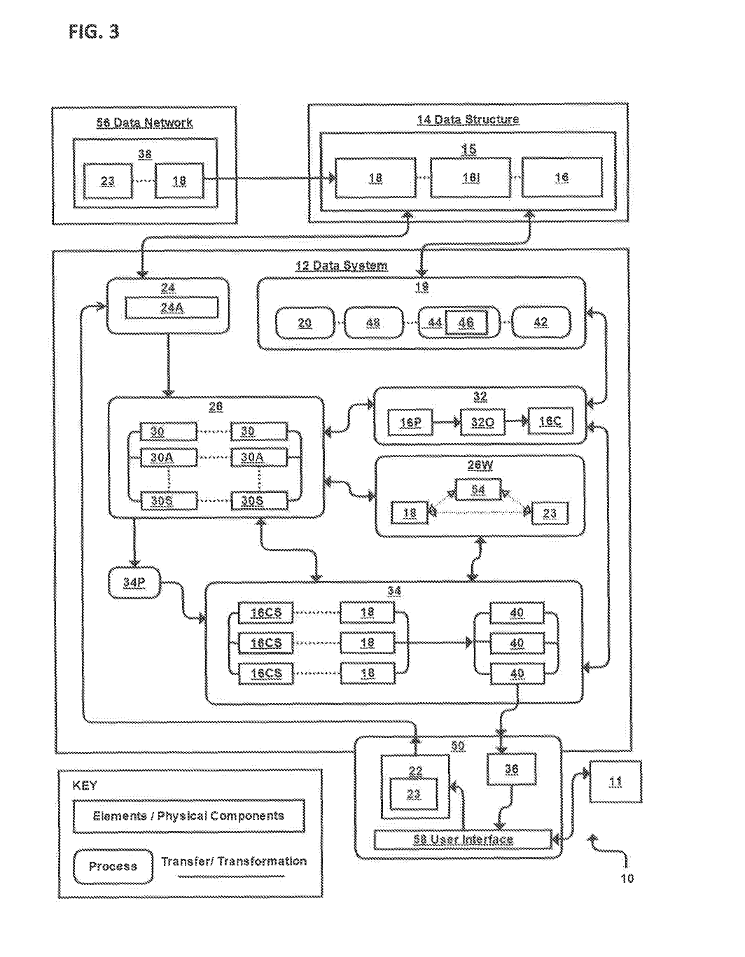

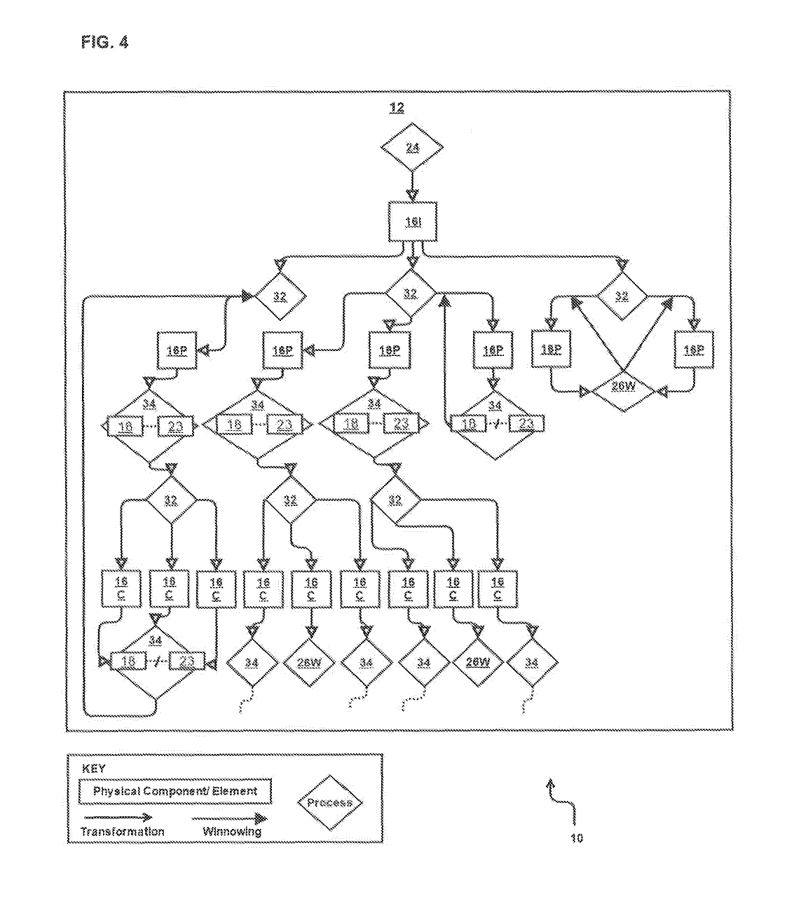

Next considering the application of the above described principles of hypotheses and hypotheses space formation and the application of certain data search mythologies to example and concept bases searches, the following will describe the operational steps performed by the DBE system 10 of the present invention on a computer 11 or other form of data system 12, as diagrammatically illustrated in FIG. 3.

The Construction of a Hypothesis Space Notation in Representing Quantified Relational Concept Hypotheses

First considering the initial hypotheses space process 24 which involves the construction and/or providing of a hypothesis space 28. That is, a set of possible concept definitions, a present embodiment of DBE 10 is implemented with concept definitions expressed as prolog predicates or SPARQL queries and using a simple hypothesis definition notation resembling both prolog predicates or SPARQL queries.

For example, in this notation, the best-guess concept (call it “r” for “relation”) exemplified by {(‘David Cameron’, ‘UK’), (‘Angela Merkel’, ‘Germany’)} would typically appear as:
[samepage=true]
X r Y<->
   X has_name Z
   Y has_name W
   Z is_head_of_state_of W

As in prolog, constants, (for example, has_name) start with lowercase letters or quotation marks, while variables start with uppercase letters. The variables in the rule head (to the left of the double arrow), X and Y are universally quantified, while Z and W, which occur only in the body (to the right of the arrow), are existentially quantified. Note that between body lines (i.e., literals, e.g. “X has_name Z”, “Y has_name W) are implicit “and”'s (e.g., “X has-name Z *and* Y has_name W”). The rule says that c is true of any pair {X,Y} if and only if there exist Z and W such that Z is called X, W is called Y, and Z is the (a) head of state of W. Because of the closed-world assumption, the usual left-pointing (“if”) arrow of a prolog predicate definition is replaced with a bidirectional (“if and only if”) arrow.

In general, object concept hypotheses will have heads of the form A a c<->, which can be read as “A is an instance of class c if and only if . . . ”. Binary relation hypotheses will have heads of the form A r B<->, which can be read as “A bears relation r to B if and only if . . . ”. Where “c” and “r” are arbitrary names for the to-be-learned concept.

By restricting the number and types of the literals that may occur in the hypothesis bodies, a large but finite hypothesis space 28 is defined.

Selecting and Assigning Prior Probabilities to Hypotheses in a Hypothesis Space

According to the present invention, before considering any hypothesis for inclusion in a h-space 28, DBE 10 has a hypotheses selection process 24 by which DBE 10 reviews and considers several possible heuristic hypothesis criteria for selecting some hypotheses 16 over others. These criteria can be broadly classified under the terms complexity, well-formedness, and relevance. Another and further important heuristic distinction and criteria when selecting some hypotheses over others is the assignment of a prior probability value to h. That is, the considerations that decide whether to assign a zero or non-zero prior probability value to h, and those considerations that help assign a reasonable number to those hypotheses h deemed worthy of probability greater than zero.

Complexity

According to the present invention, the complexity of a hypothesis 16 is determined by the numbers of literals and variables in its definition. DBE 10 prefers, that is, assigns higher prior probability, to hypotheses 16 with few literals over those with many, and assigns zero probability to all hypotheses 16 with too many literals. DBE 10 treats the number of variables in h similarly, that is, with a preference for small numbers together with a hard upper limit. There are formal arguments for the reasonableness of complexity-based prior probability values, but the hard limit is primarily driven by computational considerations; the size of the hypothesis space 28 is exponential in the number of literals allowed. Note that concepts with high complexity can be learned, if chunks of body literals can be learned as concepts beforehand, and replaced with single literals. In this way, DBE 10 achieves a low-complexity representation of what was originally a high-complexity concept. As a consequence, DBE 10 is inherently characterized by a preference for hierarchically organized knowledge. The above results in something like the familiar cognitive “readiness to learn” a concept, which consists largely in having the “building block” concepts in place.

Well-Formedness

The next possible heuristic hypothesis criteria that DBE 10 reviews and considers for selecting some hypotheses over others is that of “well-formedness” which considers the actual form, as opposed to function, of the hypotheses being reviewed. Experience has shown that certain hypotheses appear unreasonable or irrational, or strange or silly, to humans, even if technically acceptable to a data system 12. It has been found, however, that hypothesis 16 of this kind usually has the same meaning as a simpler hypothesis 16, which may appear reasonable to a human. For instance,
X a C?
   X R Y
      is an elaborate way of saying:
X a C?
   true
      that is, that X is related to C if and only if “anything.”

For another example, this definition of “married person”,
X a C<->
   X married_to Y
   Y a person
      identifies exactly the same set of objects as the simpler,
X a C<->
   X married_to Y
      because the domain of “married_to” is Y (a person).

Finally in example of an apparently irrational hypothesis,
X a C<->
   X has_Gender Y
   bruce_willis has_Gender Y
      is just a roundabout way of saying
X a C<->
   X has_Gender male
      because the domain of “has_Gender” is male (the same gender as “bruce_willis”).

In each of these cases, and according to the present invention, the simpler hypothesis 16 is guaranteed to be generated by the search, so there is no outwardly apparent reason to include the awkward or apparently irrational hypotheses 16. For this reason, in some embodiments, it is preferable to assign these apparently irrational hypotheses 16 a probability of zero (false).

However, according to other embodiments, it is also preferable to not prune such hypotheses 16 from the hypotheses space 28 during generation, since they may have well-formed specializations. For example, in case one, above, “X is somehow related to something” may be specialized to “X killed something.”

Additionally, in some embodiments, it may be preferable to catch all of irrational hypotheses 16 with a very general rule embodying the idea “don't allow a definition that is equivalent to a simpler one.”

However, as any such rule would be very costly to enforce, in other embodiments it is preferable to fall back on a collection of more specific rules for picking out zero probability “silly” hypotheses 16. Such rules can assign zero prior probability to rules in which, for instance, one body literal can be proved using the remaining ones, or those in which a body variable's value is determined.

Relevance

The next possible heuristic hypothesis criteria that the present invention DBE 10 reviews and considers for selecting some hypotheses over others is that of “relevance,” i.e., the condition of relations being connected with the matter at hand. ILP systems usually allow the user to specify which relationships should be considered relevant, and thus used in definitions. In IPL systems, this selection is typically based on a hard, 0/1 or 0 to 1 relevance. In other systems using IPL principles, this selection criteria may be “softened”, that is, to allow relationships which are not of “0” value relationship but are of less than a “1” value relation but definitions that use a 0<(relationship value)<1 are considered less probable and the relationships are accordingly assigned a probability value less than 1 and greater than 0.

In some embodiments, DBE 10 includes consideration of other kinds of relevance input criteria, such as the existence of hierarchies of classes and relations, and the possibility of definitions based on relations to specific individuals or other specific parameters (hypotheses elements). Various embodiments of DBE 10 include various correlations of the relevance input criteria which has an impact upon the correlation of relevance of “classes.”

For example, in one embodiment the following two rules are utilized. First, say that literals asserting membership in relevant classes, or relations to relevant individuals should boost the relevance score. Second, treat all super-relations of relevant relations, and super-classes of relevant classes, as equally relevant. Therefore, if the relevance of a hypothesis is defined as the minimum relevance of its component parts, then relevance, like likelihood and simplicity (the inverse of complexity, as defined above), never increases on specialization of the hypothesis.

Assigning Likelihoods to Hypotheses

In one embodiment of DBE 10, a size-based likelihood criteria is applied to relational data by constructing a closed world assumption. That is, according to the present invention, DBE 10 has some knowledge base of facts and whatever cannot be proven true given this knowledge base is assumed to be false. In DBE 10, the proof procedure for determining whether a fact is true or false may include, for example, be a raw database lookup. Alternatively, the proof procedure in other embodiments may include limited kinds of inference, as in many rdf triple stores, wherein rdf is a Resource Description Framework, which is a semantic web data model for data networks such as the internet 56. Additionally, the proof procedure in yet further embodiments, might include the full power of prolog rules. In the simplest case (with no outlier process), a hypothesis 16 must include all the examples 22 in order to have non-zero likelihood. The size of hypothesis h is just the size of its extension, that is, the set of items or tuples for which the definition is provably true.

If the knowledge base is complete and correct, it would be expected that, for instance, “is head of state of” will contain all and only pairs of people and countries for which this relation holds. However, even if some facts are missing, or some records erroneous, the relative sizes of the competing hypotheses will tend to be preserved. For instance, assuming that every head of state is a politician who lives in the country he/she heads, and that there may be politicians living in each country who are not heads of state, which would be a reasonably safe enough assumption in the real world but not necessarily in a particular, selective database, then the weaker hypothesis:
X c Y<->
   X has_name Z
   Y has_name W
   Z a politician
   Z lives_in W
      should have a larger extension, and thus lower likelihood, than the stronger “head of state of” hypothesis:
X c Y<->
   X has_name Z
   Y has_name W
   Z is_head_of_state_of W

Specializing a Hypothesis to Derive Other Hypotheses

After creating an initial hypothesis 16 that is in accordance with an example 22, referred to hereafter as an example-covering hypothesis 16, DBE 10 may generate additional specific hypotheses 16 from the original example covering hypothesis 16 by applying specialization operators 32O. Specialization operators essentially add parameters or factors to the original example covered by the original example covering hypothesis, thereby creating further examples related to and based upon the original example with each new example generated by application of one or more specialization operators results in a new example-covering hypothesis related to the original example-covering hypothesis.

In a present embodiment, DBE 10 includes four specialization operators 32O, which include:
add_literal, which adds a literal;
narrow_relation, which replaces the relation (predicate) in some literal with an immediate sub-relation;
collapse_variable, which replaces all instances of one variable with another variable; and
instantiate_variable which replaces a variable with a constant.

In this present embodiment, DBE 10 applies these specialization operations recursively to generate all well-formed hypotheses 16 up to a certain complexity, which as described above is currently measured in number of literals and number of variables, that cover a sufficient number of the examples. If any hypothesis fails to cover enough examples, then no specialization of it will, either, so the entire sub-tree of specializations rooted at such a definition can be ignored. The next following discussions describe these operators.

Specialization Operator 1: Adding a Literal

The first specialization operator of this present embodiment is, as stated, add_literal, which adds a literal. The new literal must include exactly one variable that occurs in the head or a previously-added body literal, and one new variable.

For example, the following:
X c Y<->
   Z has_name X
   W has_name Y
      gives rise to:
X c Y<->
   Z has_name X
   W has_name Y
   Z P Q

In the above example, the new literal has an unspecified relation, denoted by the variable P. This hypothesis 16 is not considered well-formed, but subsequent operations will specify it, yielding well-formed descendants.

Specialization Operator 2: Narrowing a Literal's Relation

The second specialization operator is narrow_relation, which replaces the relation (predicate) in some literal with an immediate sub-relation. This operation narrows the relation in a single literal by the smallest possible step. If the relation is a variable (as for example, a newly added literal), then it is instantiated to a most-general relation (one that is not a sub-relation of any other relation). If the literal already has a relation specified, it can be made more specific by replacing that relation with an immediate accurate sub-relation.

For example, the following hypothesis:
X c Y<->
   Z has_name X
   W has_name Y
   Z knows W
      can be transformed into:
X c Y<->
   Z has_name X
   W has_name Y
   Z friend_of W

In this example, “friend_of” is a sub-relation of “knows.” That is, in this example, whenever A is a friend of B, A knows B, however, as the laws of logic require, A may know B without being B's friend. Moreover, in this example, “friend_of” is an immediate sub-relation of “knows.” That is, there is no intermediate relation R in the knowledge base such that “friend_of” is a sub-relation of R and R is a further sub-relation of “knows.”

Specialization Operator 3: Collapsing Two Variables into One

In this specialization operator, “collapsing” one variable into another means replacing every instance of the to-be-eliminated variable with the other one. In this embodiment, W is collapsed into Z such that the following hypothesis:
X c Y<->
   X knows Z
   Y knows W
      transforms into:
X c Y<->
   X knows Z
   Y knows Z

The original hypothesis 16 says that the pair X,Y are related if X knows someone and Y knows someone, not a particularly interesting concept as it is so broad that may encompass practically everything. However, in the second hypothesis 16, the result of collapsing says that the pair is in a relationship if there is someone that both X and Y know, a much more useful and interesting concept.

Specialization Operator 4: Instantiating a Variable

In the fourth specialization operator, instantiating a variable means replacing every instance of that variable with a constant (object).
X a c<->
   X knows Z
   Z knows W
      becomes
X a c<->
   X knows Z
   Z knows person3453

The original hypothesis 16 says that X knows someone who knows anyone else, again, a concept so broad that it may encompass a multitude of situations. However, the second hypothesis says that X knows someone who knows a particular person “person3453.” This takes the (uninteresting) concept “knows someone who knows someone” to the (interesting) one “knows someone who knows person3453.” DBE 10, further includes certain operators that add and narrow class constraints before considering instantiation because the number of possible instantiations may be very large.

For example, in one embodiment, DBE 10 can find the possible instantiations for a variable, under the assumption that some number of examples must be covered by the result, by a query derived from the parent concept definition. Given the above parent concept, and supposing that a legal instantiation must cover the example person32, a legal instantiation of W must satisfy:
W a legal_instantiation<->
   person32 knows Z
   Z knows W

Hypothesis Search and Scoring Methods and Processes

Now considering an overview of the hypothesis search and scoring methods and processes implemented in the present invention. It is necessary, in order to perform an example or concept based search operation, for DBE 10 to find a set of hypotheses 16 with non-zero prior probability values that cover or nearly cover the examples or concepts 22 specified for the search. When it is necessary to assign a prior probability value and a likelihood to each of these hypotheses 16 that cover or nearly cover the specified examples or concepts 22.

As described, DBE 10 performs this operation in two separate sub-steps or processes. In the first sub-step, generating a lattice of example or concept covering hypotheses 16 and, in the second sub-step, scoring a subset or subsets of the hypotheses 16 in the lattice 30 of hypotheses 16. These two sub-steps, according to one embodiment of the present invention, will now be described in greater detail.

First considering the lattice generating process 26, the lattice 30 of example or concept covering hypotheses 16 is initially rooted at some very simple initial hypothesis 16I, such as “true.” One or more lattice arcs 30A are then generated, wherein each lattice arc is comprised of a “parent” hypothesis 16P and one or more “children” hypothesis 16C. A “parent” hypothesis is a member of the initial lattice and rooted in the simple initial hypothesis 16. Whereas, “children” hypotheses 16C are those hypotheses generated from the parent hypothesis 16P by a specialization process 32 utilizing a specialization operation 32O or sequence of specialization operations 32O. Each lattice arc 30A thereby represents a “specialized” relation between the “parent” and “children” hypotheses 16P, 16C.

Each specialization step of the specialization process 32 typically creates a number of children hypotheses 16, but not all of the resulting children hypotheses 16C need to be considered, in turn, for further specialization. In addition, a specialization may not cover the specified examples or concepts 22. Testing the children hypotheses 16C resulting from specialization against the specified examples or concepts defined for the search may prune the lattice drastically (see, for example, the further discussion below of the winnowing process 26W). Further in this regard, even if a child hypothesis 16C resulting from a specialization operation 32 does cover the query example 22, a functionally equivalent child hypothesis 16C may have already been generated by some other sequence of specialization operators. Thus, the desired child hypothesis 16C may already be in the lattice, obviating the need for that lattice branch and the resultant child hypothesis 16C.

The lattice-building step is illustrated and summarized by the following pseudocode:

```
build_lattice :: example set ex -> lattice lat
open = [trivial_hypothesis]
lat.parents = empty map
iter = 1
  do while open != [ ] and iter < max_iters
  h = first(open)
  open = rest(open)
  specs = specializations(h,ex)
  specs = filter(covers(ex),specs)
  for each s in specs
    if s in lat.parents.keys
        lat.parents(s) = add(h,lat.parents(s))
    else
        lat.parents(s) = [h]
        open = insert(s,open)
    endif
end
lat.leaves = find_leaves(lat)
```

Additional lattice arcs or sub-lattices may be generated by inserting successor hypotheses 16C, that is, child hypothesis 16C generated by the lattice construction process into the process at the “open”” step of the process. The order of the successor hypotheses 16C to be inserted at the “open” step of the process are preferably selected according to their promise, so that the most promising hypotheses 16 have their successors generated first. In this regard, and for purposes of present implementations of DBE 10, promise is reasonably defined as an increasing function of example coverage, hypothesis relevance, and simplicity. All of these criteria either decrease or stay the same as specializations are applied, thus the promise function defines a maximum for the whole sub-lattice that specializes a hypothesis.

In the second step of the process executed by DBE 10, which is executed after the construction of the lattice, the DBE 10 process scores subsets of the hypotheses 16 in the lattice of hypotheses 16. As described briefly above, determining and computing the likelihood of a hypothesis 16 requires finding and counting all the items or tuples that match the hypothesis 16. As this process step is a potentially resource intensive query, DBE 10 accordingly minimizes the subset or sets for which likelihood is determined.

The scoring process for a subset of hypotheses 16 in a present embodiment of DBE 10 is illustrated and summarized by the following pseudocode:

```
score_lattice :: lattice lat -> lattice lat
let good_hypos = [ ]
let to_do = lat.leaves
to_do = map(score,to_do) # adding extensions, scores to hypos
max_likelihood = max(likelihoods of to_do)
do while to_do != empty
  to_do = filter(likelihood > tolerance*max_likelihood,to_do)
  good = add(todo,good)
  to_do = lat.parents(to_do)
end
```

By comparing generated hypotheses 16 to the most specific example covering hypothesis, DBE 10 eliminates overly bulky parent hypotheses 16P and their children hypotheses 16C. DBE 10 may also remove overly inclusive hypothesis 16 and all of their lattice ancestors. That is, parent hypothesis 16P reaching back through one or more “generations” of parent/child specialization operations, thus DBE 10 enables pruning entire lattice branches from further consideration. In general, these winnowing processes are based upon the previously discussed criteria 54 of complexity, formedness and relevance of a given hypothesis 16. Such winnowing processes 26W allow DBE 10 to reduce or winnow the number of hypotheses 16 in a hypothesis lattice to the most useful hypotheses 16, and eventually, to candidate solution hypotheses 16CS. It is to be noted that these winnowing processes 26W are preferably performed during generation of the hypotheses lattice, but may be performed after completion of the lattice 30.

Results of the Lattice Construction and Further Reduction of the Lattice

DBE 10 generates an artificial knowledge base with a fairly rich and well-controlled ontology through the above described methods. Using such a constructed world makes it easy to recognize when the process is yielding reasonable answers 36. It will be noted that in a typical application, discussed and illustrated further below, the initial knowledge base may include a wide variety of elements 18E. For example, a variety of facts about people (e.g., gender, age), their relations to other people (e.g., friendship, marriage), to institutions (e.g., membership), and even their relations to dogs (e.g., master, owner, allergies). It may also contain, again for example, several events, such as thefts and gift-givings, and facts about what people and objects played which roles in these events. It may also include class hierarchies, (e.g., dog/mammal/animal/creature/physical thing/thing), and relation hierarchies, (e.g., friends/knows, giver/source).

It should be noted that if the above described lattice generation process 26 is merely executed by rote without the novel scoring processes 34 of the present invention, the resulting knowledge base may contain a substantial number of unneeded, redundant, or unnecessary hypotheses 16. This may make the execution of a query 22 unnecessarily burdensome, inefficient, and cumbersome as it may generate an unnecessary number of irrelevant or confusing example 22 to hypothesis 16 comparisons. Thus, the previously discussed winnowing processes of DBE 10 winnows, or reduces, the number of hypotheses 16 in a hypothesis lattice 30 to the more useful hypotheses 16 and improves the overall efficiency of the method and the system.

The following will discuss examples of the facts, knowledge, events and relationships of a DBE 10 generated knowledge base in further detail to illustrate the operation and results of operation of the present invention in winnowing the hypotheses of the lattice to increase the efficiency of the lattice in executing queries.

Knowledge Base: Class Membership

First considering simple class membership and class inferences, and illustrating such through an example operation of the present invention. Given some number of example dogs, for instance, what hypotheses 16 are probable, and what other objects are deemed “like” the examples 22? Given the one example “dog1”, here are the top five hypotheses 16, and their posterior probabilities:
A a c<->
   A isTransferredThingIn theft1
   0.2146
A a c<->
   A partOf theft1
   A type Dog
   0.1947
      A a c<->
   A partOf B
   A type Dog
   0.0789
A a c<->
   A type Dog
   0.0731
A a c<->
   A partOf theft1
   0.0716

This example has the distinctive property of being part of a theft event 1, so the “is a dog” hypothesis 16 comes in behind a hypotheses 16 based on theft event 1. The top scoring objects, each accompanied by the probability that it is a member of the (unknown) concept from which the example was drawn, includes:

| | | |
|---|---|---|
| dog1 | 1.000 | (stolen thing) |
| person4 | 0.5168 | (thief) |
| person1 | 0.5168 | (victim) |
| dog11 | 0.2802 | |
| dog13 | 0.2726 | |

With two example dogs, this class-based hypothesis 16 takes the lead:
A a c<->
A type Dog
0.6170
A a c<->
A type Animal
0.1441
A a c<->
A type Creature
0.0628
A a c<->
A type PhysicalThing
0.0533
B a c<->
A friendsWith person3
A master B
0.0527

As may be seen from the above, the most specific class, dog is in the lead, with more general classes behind, and joined by one complicated one, “dog owned by friend of person3” in fifth place. Generalizations based on this posterior distribution over hypotheses 16 thereby heavily favor dogs:

| | |
|---|---|
| dog2 | 1.000 |
| dog1 | 1.000 |
| dog4 | 1.000 |
| dog3 | 1.000 |
| dog14 | 0.947 |
| dog13 | 0.947 |
| dog12 | 0.947 |
| dog11 | 0.947 |
| person4 | 0.298 |
| person3 | 0.298 |

Knowledge Base: Relation to Specific Individual

As illustrated by the one-dog example discussed above, sometimes what distinguishes an example or set of examples is a relation to a specific individual, (e.g., in the above example “theft event 1”). Adding a second example (person 1) with that distinctive commonality of the above example, it results in the following set of top-scoring hypotheses:
A a c<->
   A partOf theft1
   0.5754
A a c<->
   A partOf theft1
   A type Thing {<---vapid literal}
   0.2117
B a c<->
   B partOf A
   B partOf theft1
   0.0779
B a c<->
   B partOf A{<---this literal redundant}
   B partOf theft1{<---with this one}
   A type Thing
   0.0286
A a c<->
   A type Male
   0.01899

Here, it can be seen that the “part of theft 1” hypothesis 16P (and minor variants 16C) pulling in to first place. Generalization is essentially all and only to participants in this event, despite some ill-formed hypotheses. Therefore, in some embodiments, it is preferable to filter these out. Here are the top five:

| | | |
|---|---|---|
| Pperson1 | 1.000 | (victim) |
| Ddog1 | 1.000 | (stolen thing) |
| person4 | 1.000 | (thief) |
| person3 | 0.092 | |
| person11 | 0.092 | |

Knowledge Base: Role-Based

Given two examples 16E, such as (dog1 and chocolateBar1), of things that played the role of “transferred thing” in a transfer event, DBE 10 may find the following top-scoring hypotheses:
B a c<->
   person1 partOf A
   B isTransferredThingIn A
   0.2011
B a c<->
   B isTransferredThingIn A
   0.1822
B a c<->
   B partOf A
   0.0897
A a c<->
   A type PhysicalThing
   0.0718
B a c<->
   person1 partOf A
   B partOf A
   0.0708

Generalization is strongest to the other item (book1) that played this role in a transfer event.

| | |
|---|---|
| Ddog1 | 0.9999 |
| chocolateBar1 | 0.9999 |
| book1 | 0.6068 |
| person4 | 0.5060 |
| person3 | 0.5060 |
| person1 | 0.5060 |
| person12 | 0.3239 |
| person11 | 0.3239 |
| theftWave1 | 0.2848 |
| theft1 | 0.2848 |

DBE Embodiments for Simple Binary Relations

The DBE 10 method is not limited to object concepts. Accordingly, systems implemented according to DBE 10 may also learn and apply binary relations as well. Indeed, those skilled in the art will also appreciate that the DBE 10 method and systems may be extended to n-ary (i.e., tertiary, quaternary, quinary, senary) relations. For example, referring to the above examples and assuming as a binary relation example a master-dog pair to see what kind of inferences DBE 10 would generate, the following illustrates the top five resulting hypotheses 16:
A r B<->
   A isGiverIn giveEvt1
   A master B
   0.3183
A r B<->
   A master B
   A type Male
   0.1592
A r B<->
   A isGiverIn giveEvt1
   A master B
   A type Male
   0.1171
B r A<->
   B master A
   0.1082
A r B<->
   A friendsWith person3
   A master B
   0.0796

While the “master” relation shows up in all of these, there are also some other, peculiar properties of this example, (e.g., the master's role as giver in give event 1), that are having a strong influence on the results. The top-scoring generalization pairs are all dog-master pairs, but the probabilities show that there is considerable uncertainty about whether many of them belong.

| | |
|---|---|
| person1, dog1 | 1.0000 |
| person11, dog11 | 0.3509 |
| person2, dog3 | 0.2591 |
| person2, dog4 | 0.1951 |
| person2, dog2 | 0.1951 |
| person12, dog13 | 0.1690 |
| person12, dog14 | 0.1583 |
| person12, dog12 | 0.1583 |

Adding a second example, (e.g., person2, dog2) substantially clarified the results. The following three hypotheses 16 account for essentially all the posterior probability mass, with the top-ranked one accounting for 94% the posterior probability mass.
B r A<->
   B master A
   0.9362
C r A<->
   C master A
   B master A
   0.0466
B r C<->
   B master A
   B master C
   A type Male
   0.0171

As can be seen, the results show that generalization is to all and only dog-master pairs, only this time with probability very near 1, in every case.

DBE Applied to More Complex Binary Relations

DBE 10 may also generate and identify multi-arc relations. For example, given one example of a pair (person11, elks) of a person and an organization to which someone they know belongs, DBE 10 may generate and identify high-scoring hypotheses 16 such as:
A r C<->
   A marriedTo B
   B member C
   0.2550
A r C<->
   A knows B
   B member C
   A type Criminal
   0.1876
A r C<->
   B friendsWith A
   B member C
   0.1700
A r C<->
   B knows A
   B member C
   0.1275
B r C<->
   A knows B
   A member C
   A type PublicEmployee
   0.0938

Though some accidental properties of this particular example creep into the definitions (e.g., the person is married to the person who is a member of the organization) the core of “knows a member of” is in all of the hypotheses 16. Generalization, however, while of variable certainty due to the incorporation of these accidental properties, is significant only to two pairs fitting this core relation.

| | |
|---|---|
| person11, elks | 0.9999 |
| person13, elks | 0.4884 |
| person2, elks | 0.3825 |
| person3, elks | 0.3600 |

Proportional Analogies

As discussed above, solving a proportional analogy essentially comprises the step of learning a binary relation concept, according to the methods implemented in DBE 10, plus the execution of two additional steps: (1) the first being to select the subset of the generalization results that match the given half of the to-be-completed example, and (2) the second being to renormalize the generalization probabilities to sum to one over this set.

Given the problem:
dog1,theft1::chocolateBar1,X
   the only solution with significant posterior probability is X=giveEvt1 (with probability near 1), because the most probable hypothesis 16, by far, is:
Y r X<->
   Y isTransferredThingIn X.

### Further Embodiments and Aspects of the Present Invention

The above descriptions of the present invention have been primarily directed to core methods, processes, structures and mechanisms of DBE 10. It will be realized by those of ordinary skill in the relevant arts that DBE 10 may and in certain implements will or does include further processes, structures and mechanisms.

For example, DBE 10 may incorporate a user interface allowing a user to identify objects by a user readable and understandable name rather than an identified string as typically used internally to the method and system. Such as interface would preferably include mechanisms supporting tolerance and/or support for spelling variations and errors, and/or corresponding correction mechanisms, including the ability to suggest alternate or corrected spellings.

In yet other embodiments of DBE 10, filters may be employed for eliminating “silly” hypotheses 16. In some instances, these filters may have adjustable elimination thresholds to allow the user to direct DBE 10 to consider hypotheses 16 which have greater or lesser levels of complexity, formedness, and/or relevance. Such adjustable level filters, which may be readily implemented in the hypothesis filter processes 26W described herein would allow a user to explore hypotheses 16 having greater or lesser levels of rationality or relevance of, put another way, greater or lesser levels of “silliness”.

In yet other implementations of DBE 10, the hypothesis 16 extension process for generating and selecting further hypotheses 16, as described above, may be replaced or supplemented by a likelihood model that allows a sample to be drawn, (with small probability) from one or more larger sets, (e.g., lattice ancestors). This modification would provide a basic method and mechanism for generating, or learning, a correct concept or example 16E, even when some information necessary for proving one of the candidate example is missing. Such a mechanism or method could be readily extended to inform a user exactly what facts are missing and which facts, if known, would allow the process to succeed.

This likelihood process would allow a DBE 10 system or process to essentially execute a common pattern of human reasoning. That is, and by way of example of this model of human reasoning, if someone starts talking about Abraham Lincoln, Andrew Jackson, and John Tyler, a listener who has never heard of John Tyler may infer (a) it is probably presidents of the USA that are being discussed, and (b) John Tyler was a president. Thus, DBE 10 can provide a process analogous to human reasoning models at a significant increase in processing speed in comparison to other prior art models.

Still other novel processes analogous to human reasoning models, such as bootstrapping, may be incorporated into embodiments of DBE 10. In one embodiment of DBE 10, the sub-process of “bootstrapping” involves breaking the task of learning a complex concept or example 16E down into a sequence of simpler tasks. The system thus learns the “building block” concepts first, and then assembles these building block concepts or examples 16E into a simpler representation of the originally complex concept. It will be recognized by those of ordinary skill in the relevant arts that the DBE 10 method and system, in the embodiments described herein, already describes and supports uni-directional bootstrapping, that is, construction of the building-blocks first.

However, in yet further embodiments of DBE 10, the information can flow both ways. That is, and for example, if there is residual uncertainty about the true definition of a building block, that is, an example 16E or concept, then good definitions for the complex concept or example 16E may be achieved through example 16E matching. Specifically, matching may help resolve that uncertainty by suggesting the use of one building block definition rather than another.

Yet another embodiment of DBE 10 incorporates a human reasoning model that utilizes combinations of explicit definitions with possibly uncertain or indefinite examples 16E. That is, and stated another way, examples or concepts 16E expressed in natural (i.e., human) language is usually not sufficiently precise to lead directly to a correct hypothesis 16. However, utilizing DBE 10, even imprecise human language can help to narrow or focus the search of relations, classes, and individuals associated with the terms in the definitions. Thereby simplifying search and reducing the number of examples 16E required. This information and subsequent process based thereon would naturally become subset processes of the “relevance” criteria, as discussed above.

### Further Detailed Descriptions of One Embodiment of the Invention

Having herein above described the general methods, processes, structures and operations of the present invention, the following will describe and discuss further aspects and context of the present in greater depth and detail with reference to FIG. 3 herein. As previously stated, the present invention, DBE 10, comprises a method or process for execution in a data system for example or concept based search operations of a data structure, such as a database, a knowledge base or data residing in or distributed across a system or network. The present description will comprise a detailed overview and summary description with corresponding drawings of the structures and the methods and processes of a presently preferred embodiment of DBE 10.

First considering the present invention briefly and in summary, to provide a context for the following more detailed descriptions of the present invention, DBE 10, performs searches, such as example-based or concept-based searches, of a data structure, in two steps. In the first step, DBE 10 generates a closed assumption hypotheses space (h-space) that includes a lattice of example-covering initial parent hypotheses selected from a hypotheses data structure according to a predetermined criteria, wherein the initial parent hypotheses selected from the hypotheses data structure have or are assigned non-zero prior probabilities of correctness and relevance, which may be alternately expressed as probability and likelihood. DBE 10 generates and adds child hypotheses to the lattice wherein the child hypotheses are generated from the parent hypotheses by specialization operators.

In the second step, and upon receiving a query comprised of an example or concept to be searched, DBE 10 selects one or more hypotheses from the lattice as potential solutions of the query by comparing the query example with the hypotheses selected from the lattice and scoring the hypotheses of at least one subset or subsets of the hypotheses selected from the lattice of according to a criteria of relevance to the query example or partial example, the response to the query then being the hypothesis or hypotheses from the lattice having the highest comparison score or scores greater than a predetermined lower limit of relevance.

Referring to FIG. 3 for a detailed description of one embodiment of the above described operation of the DBE 10. As shown therein, the DBE 10 resides in a data system 12 that includes or otherwise has access to a data structure 14 that contains a plurality of hypotheses 16, each of which in turn typically includes one or more hypotheses elements 18, including “examples” 16E. In general, and for purposes of the following descriptions of the invention, an example 16E is a fact or item of information that defines or is part of a hypotheses 16 or query example 36, which will be described below. A hypothesis 16 is defined as a proposed explanation for a phenomenon, such as a statement of fact or a relationship. A hypothesis element 18 may, in turn, may be, for example, a fact, a literal, a relationship, an identification, an event, an action or any other form of information item related to and defining the hypothesis.

As illustrated, the DBE 10 system includes processes comprising a hypotheses space process 20 and an initial hypotheses selection process 24. By which, DBE 10, in response to one or more complete or partial query examples 22, selects initial hypotheses 16I from the hypotheses 16 in data structure 14. The selection of initial hypotheses 16I by hypotheses selection process 24 is based upon a heuristic selection criteria 24A. The selection criteria 24A may include, for example, complexity, formedness, and relevance. Complexity is the number of variables in the definition of an initial hypotheses 16I. Formedness relates to whether the initial hypotheses 16I under consideration appears rational under the parameters of the proposed query or, stated another way and in the alternative, the degree of similarity between the initial parent hypothesis under consideration and a second initial parent hypothesis of lesser complexity. Relevance is whether there is a valid relationship between the initial parent hypothesis 16I and the query example 22, or stated another way, whether there exists at least one relationship between the query example 22 and the initial hypothesis 16I under consideration.

As initial hypotheses selection process 24 selects initial hypotheses 16I, a lattice generation process 26 receives the selected initial hypotheses 16I. DBE 10 then constructs a hypotheses space 28 to contain the selected initial hypotheses 16I. Next, DBE 10 organizes the selected initial hypotheses 16I into a hypotheses lattice 30 containing one or more lattice arcs 30A in hypotheses space 28. Wherein each lattice arc 30A corresponds to an initial hypothesis 16I. It should be noted that hypotheses space 28 may further include sub-lattice arcs 30S generated possibly during the initial generation of lattice arcs 30A to store hypotheses 16 related to the selected initial hypotheses 16I. The hypotheses space 28 may also include subsequent hypotheses typically generated by a subsequent hypotheses specialization process 32, described next below.

The initial hypotheses 16I occupying the lattice arcs 30A, and sub-lattice arcs 30S, if any, will typically be initially rooted in relatively simple hypotheses 16 and thus may be limited in number and scope. For this reason, hypotheses specialization process 32 of DBE 10 will increase and expand the initial hypotheses 16I in lattice arcs 30A of hypotheses space 28 by operating upon the initially selected hypotheses 16I with one or more hypotheses specialization operators 32O. The hypotheses specialization process 32 receives one or more of the initially selected hypotheses 16I, referred to as child hypotheses 16C, and generates from each selected parent hypothesis 16P one or more child hypotheses 16C by operation of one or more hypotheses specialization operators 32O.

In a present embodiment of DBE 10, the specialization operators 32O, may include, but are not limited to (1) the addition of a literal to a parent hypothesis, (2) the narrowing of a literal relationship by replacing a predicate of a literal with an immediate sub-relation predicate, (3) the collapse of a variable by replacing all instances of the variable with another variable, and (4) the instantiating of a variable by replacing the variable with a constant.

After specialization, the resulting child hypotheses 16C are stored in the lattice arcs 30A or sub-lattice arcs 30S of hypotheses space 28 that correspond to with parent hypotheses 16P from which they are generated. Each lattice arc 30A is thereby typically comprises a parent hypothesis and one or more children hypotheses. A parent hypothesis 16P is a hypothesis 16 that is a member of the corresponding initial lattice arc 30A and is rooted in the simple initial hypothesis 16I. The children or child hypotheses 16C are typically generated from the parent hypothesis 16P by a hypotheses specialization operators or sequence of hypotheses specialization operators. Each lattice arc thereby represents a specialized relation between the parent hypothesis 16P and child hypotheses 16C.

Each specialization step typically creates a number of children hypotheses, but not all of the resulting children hypotheses need to be considered, in turn, for further specialization. In addition, a specialization may not cover the specified examples or concepts and testing the children hypotheses resulting from specialization against the specified examples or concepts defined for the search may prunes the lattice drastically. Further in this regard, even if a child hypothesis resulting from a specialization operation does cover the example or examples, an equivalent child hypothesis may have already been generated by some other sequence of specialization operators and thus may already be in the lattice, thus obviating the need to add the later child hypothesis.

Hypotheses specialization process 32 may further generate still more additional lattice arcs 30A or sub-lattice arcs 30S by operation upon successor hypotheses 16C. For example, by selecting a child hypothesis 16C to be a next generation parent hypothesis 16P, or a “successor” hypothesis 16C. DBE 10 then uses the selected child hypothesis 16C as an input successor hypothesis 16C to hypotheses specialization process 32 to generate one or more new child hypotheses 16C from the previously generated child hypotheses 16C. So that each child hypothesis 16C, or successor hypothesis 16C, is effectively a parent hypothesis 16P for one or more next generation child hypotheses 16C. The successor hypotheses to be used for generation of further child hypotheses 16C are preferably selected according to their promise so that the most promising hypotheses have their successors generated first. In this regard, and for purposes of present implementations of DBE 10, promise 40 is reasonably defined as an increasing function of example coverage, hypothesis relevance, and simplicity. All of these criteria 54 either decrease or stay the same as specializations are applied, so this kind of promise function defines a maximum for a whole sub-lattice 30S that specializes a parent hypothesis 16P or successor hypothesis 16C.

As recognized by the present invention, the hypothesis lattice 30 generated by initial hypotheses selection process 24 and by lattice generation process 26 may contain an excessively large number of hypotheses 16 and corresponding lattice arcs 30A and sub-lattice arcs 30S which may consequently slow example searches. The lattices 30 and sub-lattices 30S may, more specifically, include hypotheses 16 which are effectively non-relevant to potential query examples 22. Such hypotheses 16 may be non-relevant because the hypotheses 16 are overly inclusive or overly exclusive relative to potential query examples 22. That is, because the hypotheses 16 cover too broad or too narrow a range of possible query examples 22 to be effectively useful or efficient in narrowing the potential results of a search, or because the hypotheses 16 are too similar to other hypotheses 16. For this reason, DBE 10 may typically include a lattice winnowing process 26W. This winnowing process winnows, or reduces, the number of any or all of the hypotheses (e.g., initial hypotheses 16I, parent hypotheses 16P and child hypotheses 16C) in a hypothesis lattice 30. This allows DBE 10 to identify and select the more useful hypotheses 16 of the hypotheses lattice 30.

In present embodiments of DBE 10, the lattice winnowing process 26W may be executed during selection and generation of the hypotheses 16I, 16P, 16C of the lattice or after completion of the hypotheses lattice 30. In certain embodiments, the winnowing of initial hypotheses 16I may be performed by and during operation of initial hypotheses selection process 24 and by initial hypotheses selection process 24.

In present embodiments of DBE 10, lattice winnowing process 26W identifies those hypotheses 16 of the hypotheses lattice 30 to be removed by employing a one or more of a range of criteria 54. For example, lattice winnowing process 26W may select successive hypotheses 16 of the entire hypotheses lattice 30, or only hypotheses 16 of a certain class, such as child hypotheses 16C, or hypotheses 16 according to some predetermined criteria. In other embodiments, the lattice winnowing process 26W may select a hypotheses 16 of the hypotheses lattice 30 for potential elimination by comparing the hypotheses 16 to one or more of the most-specific examples covering the hypothesis 16 and calculating and determining the degree of relevance. In the present embodiment of DBE 10, the winnowing process 26W is based upon the above discussed criteria of complexity, formedness and relevance of a given hypothesis 16.

Lastly, in addition to eliminating overly inclusive hypotheses 16 from a hypotheses lattice 30, lattice winnowing process 26W will also preferably eliminate, and remove from the hypotheses lattice 30, all of the lattice ancestors of each hypothesis 16 selected for removal from the hypotheses lattice 30. That is, the winnowing process 26W will identify and remove the parent hypothesis 16P of each removed child hypothesis 16C reaching back through one or more “generations” of parent/child hypotheses 16P/16C generation operations.

In the second step of the processes comprising DBE 10, and as further illustrated in FIG. 3, DBE 10 includes a query scoring process 34 which receives a query example 22, which comprises a partial or incomplete example 16E, or concept, upon which a search of hypotheses lattice 30 is to be executed by DBE 10. In response to the query example 22, query scoring process 34 selects at least one and typically many hypotheses 16 from hypotheses lattice 30 for scoring by query scoring process 34 wherein the hypotheses 16 may be selected for scoring upon any of a number of criteria.

For example, query scoring process 34 may merely select the hypotheses 16 sequentially through the entire population of hypotheses 16, scoring each hypotheses 16, in turn, against the query example 22, with each hypotheses 16 of hypotheses lattice 30 thereby being a candidate solution hypotheses 16CS representing a potential solution of the query example 36. This, however, while being the simplest method is also the most time consuming.

Alternately, and in presently preferred embodiments of a DBE 10, query scoring process 34 may, for example, select candidate solution hypotheses 16CS representing potential solutions of the query example 22 by a preliminary filtering process 34P which searches hypotheses lattice 30 for hypotheses 16 containing hypothesis elements 18 corresponding to or related to query elements 23 in the query example 22. The hypotheses 16 having the greater number of corresponding hypotheses elements 18 corresponding to the query example 22 and/or the hypotheses elements 18 having the greater relevance to the combination of query elements 16E of query example 22 may then be selected as candidate solution hypotheses 16CS.

Lastly in the processes performed by DBE 10, query scoring process 34 examines all candidate solution hypotheses 16CS, however the candidate solution hypotheses 16CS were obtained. This query scoring process 34 determines for each candidate solution hypotheses 16CS, a solution likelihood value 40 representing the probability that the candidate solution hypotheses 16CS is a valid solution to the query example 23. Query scoring process 34 is performed for each candidate solution hypotheses 16CS by finding and counting and determining the degree of relevance all of the hypotheses elements 38 or tuples thereof that match at least one query element 16E of the query example 22. The query result 36 derived from the candidate solution hypothesis 16CS with the greatest valid solution score 40 will then be relayed to the user.

It will be apparent that any given query 22 may result in no valid solution scores 40, that is, no solution scores 40 high enough to represent a valid candidate solution hypothesis 16CS corresponding to the query example 22, a typical search will probably result in a range of solution scores 40. Such solution scores 40 will accordingly indicate which candidate solution hypotheses 16CS comprise possible valid answers to the query, and their relative likelihood of being the most likely answer the query or a member of a group, and relative rank within the group, of the most likely answers to the query. In this case, the query result 36 contains the highest candidate solution hypotheses 16CS along with their solution scores 40 which are relayed to the user.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

Wherefore, I/we claim:

1. A method for generalizing/learning relationship concepts of a hypotheses data structure from a very few positive examples comprising the steps of:
(a) receiving a query request in a non-query language from a user for specific information;
(b) generating a closed assumption hypotheses space having a plurality of hypotheses;
(c) applying a Bayesian based scoring rule, being based on statistical and database completeness assumptions which focuses on the destructive commodities of examples, on the plurality of hypotheses;
(d) performing at least one method for organizing, prioritizing and searching an expressive language of commonality hypotheses regarding the plurality of hypotheses; and
(e) providing a result to the user in a non-query language.

2. A method for example based searches of a hypotheses data structure in a data system, comprising the steps of:
(a) generating a closed assumption hypotheses space (h-space), including the steps of:
(a1) selecting initial parent hypotheses from the hypotheses data structure according to a predetermined criteria wherein the selected initial parent hypotheses have non-zero prior probabilities of at least one of correctness and relevance,
(a2) adding each selected initial parent hypotheses to a hypotheses lattice, and
(a3) generating and adding at least one child hypotheses to the lattice in which at least one child hypothesis is generated from a parent hypothesis of the lattice by specialization operators, and
(b) upon receiving a query example to be searched, selecting and providing at least one response to the query example consisting of at least one candidate hypothesis, comprising the steps of:
(b1) selecting the at least one candidate from the lattice as representing a potential solution of the query by comparing the query example with the at least one candidate hypothesis selected from the lattice;
(b2) scoring the at least one candidate hypothesis selected from the lattice according to a criteria of relevance to the query example;
(b3) generating a corresponding solution likelihood value for the at least one candidate hypothesis, with the solution likelihood value representing a probability that the at least one corresponding hypothesis is a valid solution to the query example, and
(b4) selecting and outputting at least one response to the query example comprising at least one candidate hypothesis selected from the lattice having a likelihood value greater than a predetermined lower limit.

3. The method for example based searches of the hypotheses data structure in the data system according to claim 2, wherein:
each of the parent hypotheses and child hypotheses from the hypotheses data structure is a proposed explanation for a phenomenon which comprises at least one of a statement of a fact or a relationship;
each of the hypotheses contains at least one hypothesis element; and
the at least one hypothesis element comprises at least one of:
a fact, a literal, a relationship, an identification, an event, an action or an information item related to and defining the hypothesis.

4. The method for example based searches of the hypotheses data structure in the data system according to claim 2, wherein:
the selection of initial parent hypotheses is based upon a heuristic selection criteria including at least one of:
complexity, relevance, and formedness;
wherein complexity is determined by a number of variables in a definition of an initial hypothesis,
relevance is an existence of at least one relationship between the query example and the at least one candidate hypothesis under consideration, and
formedness is a degree of similarity between the initial parent hypothesis under consideration and a second initial parent hypothesis of lesser complexity.

5. The method for example based searches of the hypotheses data structure in the data system according to claim 2, wherein:
the specialization operators generating child hypotheses include at least one of the addition of:
at least one literal to at least one parent hypothesis,
the narrowing of at least one literal relationship by replacing a predicate of at least one literal with an immediate sub-relation predicate,
the collapse of at least one variable by replacing all instances of the at least one variable with another variable, and
the instantiating of at least one variable by replacing the at least one variable with a constant.

6. The method for example based searches of the hypotheses data structure in the data system according to claim 2, wherein the step of adding each selected initial parent hypotheses to the hypotheses lattice comprises:
adding at least one initial parent hypothesis to a corresponding lattice arc of the lattice, and
the step of adding at least one child hypothesis to the lattice comprises adding the at least one child hypothesis to a sub-lattice arc corresponding to the lattice arc corresponding to the parent hypothesis from which the child hypothesis was generated.

7. The method for example based searches of the hypotheses data structure in the data system according to claim 2, wherein the step of adding at least one child hypothesis to the lattice further includes the step of:
adding at least one next generation child hypothesis to the lattice by:
selecting a child hypothesis to be a successor hypothesis to be operated upon by at least specialization operator,
operating upon the successor hypothesis with at least one specialization operation to generate at least one next generation child hypothesis, and
adding each next generation child hypothesis to a lattice arc of the successor hypothesis.

8. The method for example based searches of the hypotheses data structure in the data system according to claim 2, wherein the step of selecting a child hypothesis to be a successor hypothesis includes:
(1) determining a promise value for a child hypothesis in which a promise value is a function of at least one of:
an example coverage value representing a degree to which the child hypothesis matches the query example,
a hypothesis relevance value representing a degree to which the child example relates to the query example, and
a simplicity value representing the number of literals and variables defining the child hypothesis, and
(2) selecting for use as successor hypotheses the child hypotheses which have a promise value greater than a predetermined value.

9. The method for example based searches of the hypotheses data structure in the data system according to claim 2, wherein the step of generating and adding at least one child hypotheses to the lattice further comprises the step of:
eliminating non-relevant hypotheses from the lattice.

10. The method for example based searches of the hypotheses data structure in the data system according to claim 9, wherein hypotheses are selected for elimination from the lattice according to a criteria including at least one of:
being overly inclusive, being overly exclusive, being redundant with regard to other hypotheses, membership of a class of hypothesis, complexity, formedness or relevance to potential query examples.

11. The method for example based searches of the hypotheses data structure in the data system according to claim 10, wherein:
the elimination of non-relevant hypotheses from the lattice is performed during at least one of:
the addition of hypotheses and child hypotheses to the lattice, and
after generation of the hypotheses space.

12. The method for example based searches of the hypotheses data structure in the data system according to claim 2, wherein:
candidate hypotheses potentially representing a solution to the query example are selected from the lattice for scoring by at least one of:
selection of successive hypotheses from the lattice,
determination of relevance of a hypotheses to the query example, and
selection of candidate hypotheses by comparison between elements of the query example and elements of the hypotheses.

13. The method for example based searches of the hypotheses data structure in the data system according to claim 2, wherein:
scoring the candidate hypotheses by the steps of:
determining a degree of relevance of all hypotheses elements of each candidate hypothesis that matches at least one hypotheses element of the query example, and
generating for each candidate hypothesis a solution likelihood value representing the probability that the candidate hypotheses is a valid solution to the query example.

14. The method for example based searches of the hypotheses data structure in the data system according to claim 2, wherein the selection of at least one candidate hypothesis as a potential solution to the query example comprises the steps of:
comparing and ranking the candidate hypotheses having a solution likelihood value greater than a predetermined lower limit, and
selecting at least the candidate hypothesis having the greatest solution likelihood value as a solution to the query example.
